(19) United States
(12) Patent Application Publication
(10) Pub. No.: US 2008/0111484 A1
(43) Pub. Date: May 15, 2008

(54) Organic light emitting display apparatus employing anode having multi-layer structure

(76) Inventors: Do-Hyun Kwon, Suwon-si (KR); Kyung-Jin Yoo, Suwon-si (KR); Woo-Sik Jun, Suwon-si (KR); Chul-Kyu Kang, Suwon-si (KR)

Correspondence Address: Robert E. Bushnell, Suite 300, 1522 K Street, N.W., Washington, DC, 20005-1202, US

(21) Appl. No.: 11/783,554

(22) Filed: Apr. 10, 2007

(30) Foreign Application Priority Data
Nov. 10, 2006 (KR) 10-2006-0111245

(51) Int. Cl. H01J 1/62

(52) U.S. Cl. 313/506

(57) ABSTRACT

An organic light emitting display device including an anode having a multi-layer structure which can be manufactured using a simple process, has good hole transfer properties and high reflectivity, and prevents energy loss due to a drop in voltage. The organic light emitting display device includes a substrate, a thin film transistor formed on the substrate and including source and drain electrodes, a first anode patterned simultaneously with the source and drain electrodes of the thin film transistor, formed integrally with the source or drain electrode, and made out of a conductive material having a low resistance, a second anode formed on the first anode, and made out of a conductive material having a high work function, an organic layer formed on the second anode and a cathode formed on the organic layer.

### CLAIM OF PRIORITY

This application makes reference to, incorporates the same herein, and claims all benefits accruing under 35 U.S.C. §119 from an application for ORGANIC LIGHT EMITTING DISPLAY APPARATUS EMPLOYING ANODE HAVING MULTI-LAYER STRUCTURE earlier filed in the Korean Intellectual Property Office on 10 Nov. 2006 and there duly assigned Serial No. 10-2006-0111245.

### BACKGROUND OF THE INVENTION

1. Field of the Invention

The present invention relates to an organic light emitting display device, and more particularly, to an organic light emitting display device employing an anode having a multi-layer structure that can be manufactured using a simple process, have good hole transport properties and high reflectivity, and prevent energy loss due to a drop in voltage.

2. Description of the Related Art

An organic light emitting display device is a display device including an emission layer made out of an organic material between a pixel electrode and an opposite electrode. The organic light emitting display device displays an image as follows. A hole, which is injected from the pixel electrode, is transported to the emission layer through a hole transport layer, and an electron, which is injected from the opposite electrode, is transported to the emission layer through an electron transport layer by applying anode and cathode voltages to the pixel and an opposite electrode, respectively. An exciton is formed when above hole and electron combine in the emission layer. While the exciton moves from an excited state to a ground state, the exciton transports energy to a fluorescent molecule in the emission layer to emit light. The light emitted from the fluorescent molecule produces an image. Such an organic light emitting display device is formed by an active matrix (AM) type organic light emitting display device having a thin film transistor (TFT) formed on a substrate, a hole injection electrode formed on the resulting structure, an organic layer and an electron injection electrode, which are sequentially formed, in order to achieve high resolution, high definition, low power consumption and a long lifespan.

An organic light emitting display device includes source and drain electrodes electrically connected to source and drain regions and of a semiconductor layer, respectively, through contact holes formed in an inter-insulator. A planarization layer (and/or passivation layer) is formed on the inter-insulator. A pixel electrode formed on the planarization layer is electrically connected to the source or drain electrode through a via hole.

Since a thin film transistor having the above structure is manufactured by separately forming the source and drain electrodes, wires transmitting signals to source and drain electrodes and the pixel electrode, additional mask processes are required, thereby complicating the manufacturing process and increasing manufacturing costs. When a pixel electrode of the organic light emitting display device having the above stacked structure is a reflective type anode, the pixel electrode is made out of a material having a high work function to smoothly transport holes. Usually, since a material having a high work function has high resistance and low reflectivity, the material is not suitable for forming an anode for top emission. It is therefore an object of the present invention to provide an improved organic light emitting display that addresses the above problems.

### SUMMARY OF THE INVENTION

It is therefore an object of the present invention to provide for an improved design for an organic light emitting display.

It is also an object of the present invention to provide a design for an organic light emitting display that is simple to manufacture by reducing eliminating process steps and reducing costs.

It is further an object of the present invention to provide an organic light emitting display device that has good hole transport properties, high reflectivity, and prevents energy loss due to a drop in voltage.

According to an aspect of the present invention, there is provided an organic light emitting display device including a substrate, a thin film transistor arranged on the substrate and including a source electrode and a drain electrode, a first anode, a first anode, wherein the first anode and one of the source electrode and the drain electrode have at least one layer in common, are integral with each other are comprise a conductive material that has a low resistance, a second anode arranged on the first anode and comprising a conductive material having a high work function, an organic layer arranged on the second anode and a cathode arranged on the organic layer. The thin film transistor can include a buffer layer, a semiconductor layer arranged on the buffer layer, a gate insulating layer arranged on the semiconductor layer, a gate electrode arranged on the gate insulating layer, a inter-insulator arranged on the gate electrode and a planarization layer arranged on the inter-insulator, the source and the drain electrode of the thin film transistor being arranged on the planarization layer and being connected to source and drain regions respectively of the semiconductor layer through a via hole.

The first anode can be made out of a conductive material having a surface resistance less than 0.7Ω/□. The first anode can be made out of a material selected such as Al, AlNd, ACX, AlNiLa, Ag, Mo, Ti and MoW. A thickness of the first anode can be less than 0.5 μm. The second anode can be made out of a conductive material having a work function greater than 6.0 eV. The second anode can be made out of a material such as indium tin oxide and indium zinc oxide. The display device can also include a third anode made out of a conductive material and arranged between the first anode and the planarization layer, the third anode being adapted to prevent contamination of a channel of the semiconductor layer. The first anode can be made out of a material such as Al, AlNd, ACX, AlNiLa and Ag. The third anode can be made out of a material such as Mo, Ti and MoW.

According to another aspect of the present invention, there is provided an organic light emitting display device that includes a substrate, a thin film transistor arranged on the substrate and including a source electrode and a drain electrode, a first anode, wherein the first anode and one of the source electrode and the drain electrode have at least one layer in common and are integral with each other, a second anode arranged on the first anode and comprising a conductive material having a high work function, an organic layer arranged on the second anode and a cathode arranged on the organic layer. The first anode and the one of the source electrode and the drain electrode can be made out of a conductive material having a high reflectivity. The thin film transistor can include a buffer layer, a semiconductor layer arranged on the buffer layer, a gate insulating layer arranged on the semiconductor layer, a gate electrode arranged on the gate insulating layer, a inter-insulator arranged on the gate electrode and a planarization layer arranged on the inter-insulator, the source and drain electrodes of the thin film transistor being arranged on the planarization layer and being connected to source and drain regions respectively of the semiconductor layer through a via hole.

The first anode can be made out of a conductive material having reflectivity greater than 97%. The first anode can be made out of a material such as Al, AlNd, ACX, AlNiLa, Ag, Mo, Ti and MoW. The second anode can be made out of a conductive material having a work function greater than 6.0 eV. The second anode can be made out of a material such as indium tin oxide and indium zinc oxide.

The display device can further include a third anode made out of a conductive material and arranged between the first anode and the planarization layer, the third anode can be adapted to provide adhesion between the first anode and the source and drain regions of the semiconductor layer. The first anode can be made out of a material such as Al, AlNd, ACX, AlNiLa and Ag. The third anode can be made out of a material such as Mo, Ti, MoW, indium tin oxide and indium zinc oxide.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic cross-sectional view illustrating an active matrix (AM) driving type organic light emitting display device;

FIG. 2 is a schematic cross-sectional view illustrating an organic light emitting display device according to an embodiment of the present invention;

FIGS. 3 through 7 are schematic cross-sectional views illustrating a method of manufacturing the organic light emitting display device of FIG. 2 using a different mask for each operation, according to an embodiment of the present invention;

FIG. 8 is a schematic cross-sectional view illustrating an organic light emitting display device according to another embodiment of the present invention;

FIG. 9 is a schematic cross-sectional view illustrating an organic light emitting display device according to another embodiment of the present invention;

FIG. 10 is a schematic cross-sectional view illustrating an operation of forming source and drain electrodes and an anode of the organic light emitting display device of FIG. 9, according to an embodiment of the present invention; and

FIG. 11 is a schematic cross-sectional view illustrating an organic light emitting display device according to another embodiment of the present invention.

### DETAILED DESCRIPTION OF THE INVENTION

Turning now to the figures, FIG. 1 is a schematic cross-sectional view illustrating an active matrix (AM) driving type organic light emitting display device 100. Referring to FIG. 1, source and drain electrodes 15 and 16 of the organic light emitting display device 100 are electrically connected to source and drain regions 12 and 13 of a semiconductor layer 11, respectively, through contact holes 17, and are formed on an inter-insulator 114. A planarization layer (and/or passivation layer) 115 is formed on the inter-insulator 114. A pixel electrode formed on the planarization layer 115 is electrically connected to the source or drain electrode 15 or 16 through a via hole 18.

Since a thin film transistor having the above structure is manufactured by separately forming the source and drain electrodes 15 and 16, wires transmitting signals to source and drain electrodes 15 and 16, and the pixel electrode, additional mask processes are required, thereby complicating the manufacturing process and increasing manufacturing costs. When a pixel electrode 19 of the organic light emitting display device 100 having the above stacked structure is a reflective type anode, the pixel electrode 19 is made out of a material having a high work function for smoothly transporting holes. Usually, since a material having a high work function has high resistance and low reflectivity, the material is not suitable for forming an anode for a top emission display.

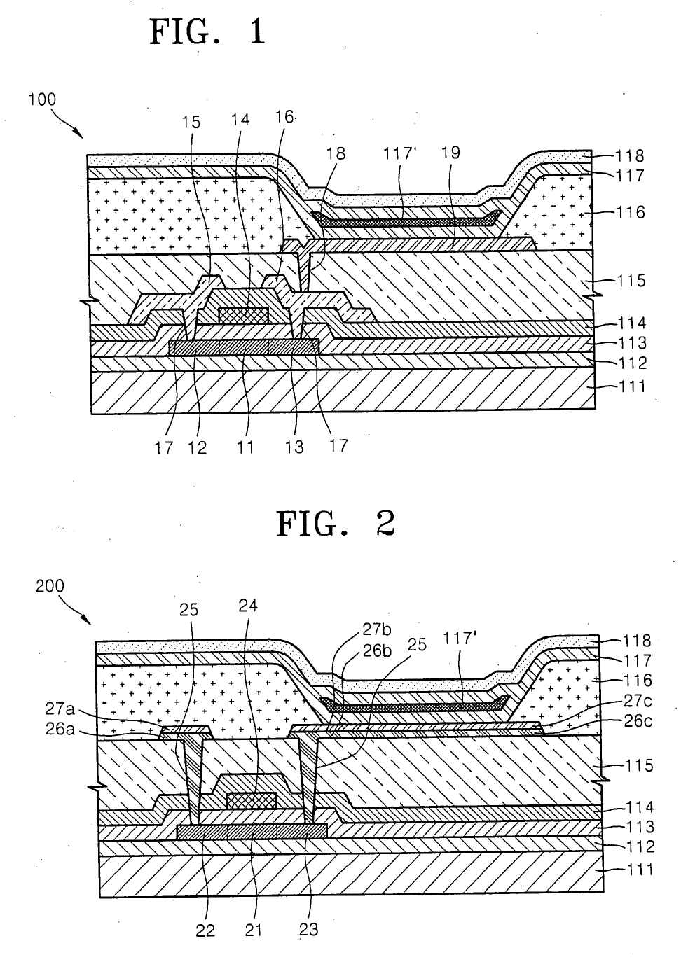

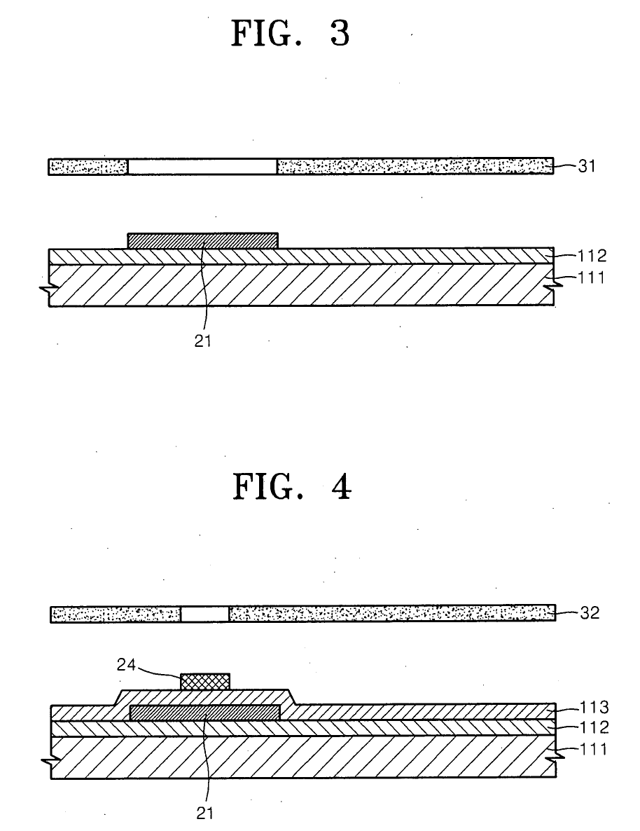

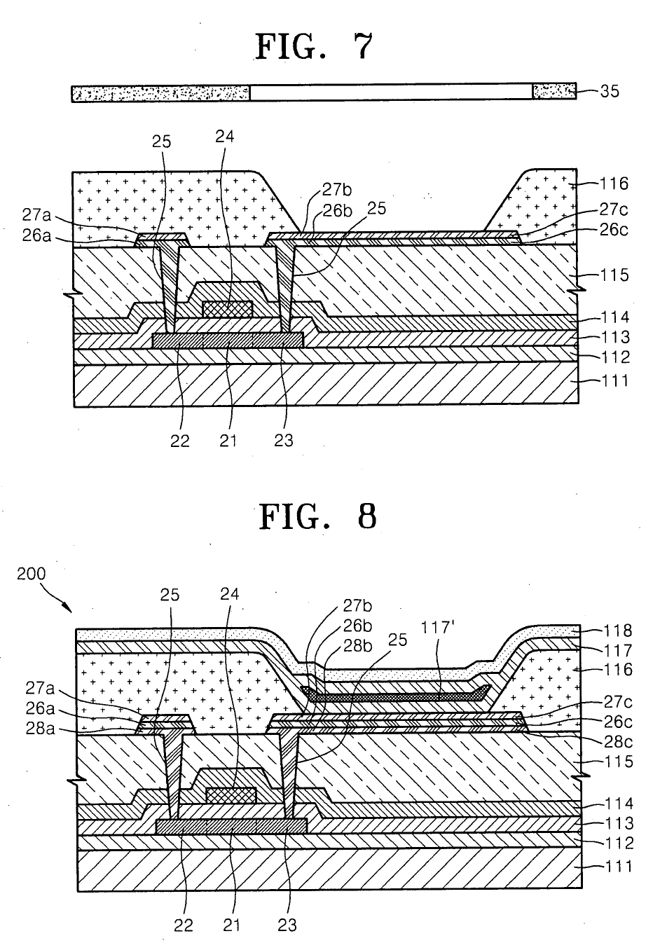

Turning now to FIGS. 2 through 7, FIG. 2 is a schematic cross-sectional view illustrating an organic light emitting display device 200 according to an embodiment of the present invention and FIGS. 3 through 7 are schematic cross-sectional views illustrating a method of manufacturing the organic light emitting display device 200 of FIG. 2 using a different mask for each operation, according to an embodiment of the present invention. Referring to FIGS. 2 through 7, an organic light emitting device electrically connected to a thin film transistor (TFT) is formed on a substrate 111. The substrate 111 can be made out of glass, plastic, metal or the like.

A buffer layer 112 made out of SiO₂ or the like is formed on the substrate 111. The buffer layer 112 prevents the diffusion of moisture or impurities generated from the substrate 111. In addition, the buffer layer 112 aids the crystallization of a semiconductor layer 21 by regulating a heat transfer velocity during the crystallization. The semiconductor layer 21 is patterned using a first mask 31, and can be an amorphous silicon thin film or a polycrystalline silicon thin film. After the semiconductor layer 21 is patterned, a gate insulating layer 113 that includes SiO₂ or the like is formed on the semiconductor layer 21 via a plasma-enhanced chemical vapor deposition (PECVD) method or the like in order to insulate the semiconductor layer 21 from a gate electrode 24.

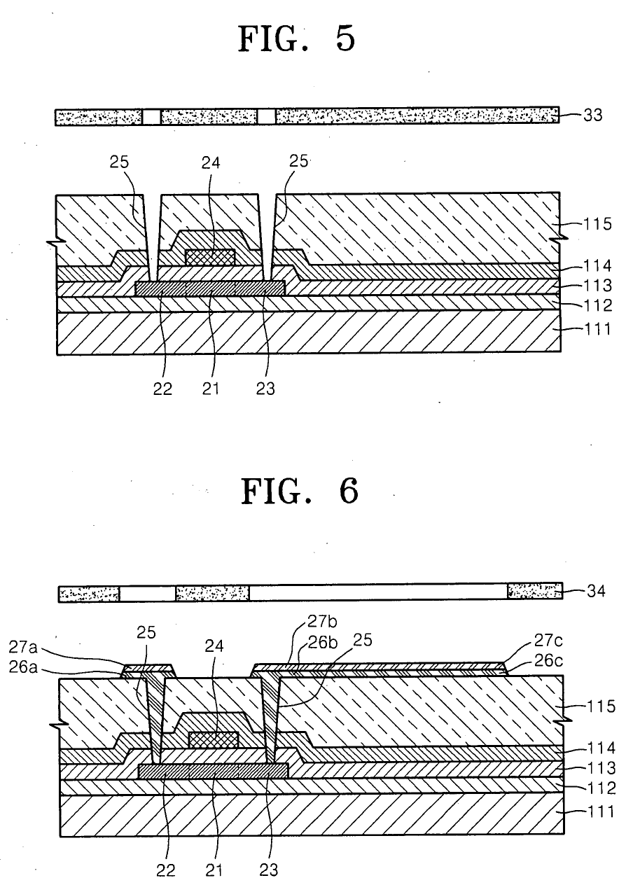

Referring now to FIG. 4, the gate electrode 24 is formed on a part of the semiconductor layer 21 by patterning using a second mask 32. A conduction path between the source electrode 26a and the drain electrode 26b (See FIG. 6) is established depending on the signal applied to the gate electrode 24. The gate electrode 24 is made out of a material such as MoW, Al/Cu, or the like suitable for the adhesion to an adjacent layer as well as the planarization and the workability of a deposited layer formed on gate electrode 24. Although not illustrated in FIGS. 2 through 7 in detail, the semiconductor layer 21 is doped with N+ or P+ type dopant using the gate electrode 24 formed as above if necessary. By doing so, the semiconductor layer 21 can include source and drain regions as well as a channel region.

An inter-insulator 114 is made out of SiO₂, SiNx or the like is formed on an upper part of the gate electrode 24 and has a single layer or multi-layer structure. A planarization layer 115 is sequentially formed on an upper part of the inter-insulator 114 to protect and level the TFT which is formed in a bottom portion of the organic light emitting display device 200. The planarization layer 115 can be formed to have various structures. The planarization layer 115 can be made out of an organic material such as benzocyclobutene (BCB), acral, or the like, or an inorganic material such as SiNx, and can be formed to have a single layer, double layer or multi-layer structure. Accordingly, the structure of the planarization layer 115 can take on various designs.

Referring to FIG. 5, using a third mask 33, via holes 25 which expose a source region 22 and a drain region 23 of the semiconductor layer 21, respectively, are formed. Referring to FIG. 6, using a fourth mask 34, source and drain electrodes 26a and 26b are formed so as to contact the source and drain regions 22 and 23, respectively, through the via holes 25. One of the source and drain electrodes 26a and 26b is also an anode of an organic light emitting device. The anode includes double layers, that is, a first anode 26c and a second anode 27c.

In the organic light emitting display device 200, the source and drain electrodes 26a and 26b function as pixel electrodes. Thus, using one mask (the fourth mask 34), the source and drain electrodes 26a and 26b and the pixel electrodes 26c and 27c are simultaneously formed. Although not illustrated in FIGS. 2 through 7, source and drain wires and the pixel wires 26c and 27c are also simultaneously formed using the fourth mask 34. The source and drain wires transmit signals to the source and drain electrodes 26a and 26b. Accordingly, the organic light emitting display device 200 can be manufactured using a simple and inexpensive method in which the number of masks is reduced, compared with a other methods in which the source and drain electrodes and the pixel electrodes are separately formed. Since the material of the first anode 26b is also used to form the pixel electrodes 26c and 27c as well as the source and drain electrodes 26a and 26b and the source and drain wires, the material is a conductive material having low resistance in order to reduce energy loss caused by a drop in voltage.

The first anode 26c can be made out of a conductive material having surface resistance Rs less than 0.7Ω/□. The surface resistance Rs refers to a value of specific resistance with respect to a material thickness to be measured for a constant surface area using a surface resistance meter. Accordingly, since materials even having the same specific resistance can have different surface resistance Rs according to the thickness of the material, surface resistance Rs can be controlled by regulating the thickness of the first anode 26c.

In the current embodiment of the present invention, the first anode 26c is made out of at least one of Al, AlNd, ACX, AlNiLa, Ag, Mo, Ti and MoW. The first anode 26c is formed to have a thickness of less than 0.5 μm. However, the present invention is not limited to these materials and thicknesses provided that the surface resistance Rs is less than 0.7Ω/□.

The second anode 27c is formed on the first anode 26c using the fourth mask 34. The second anode 27c is made out of a conductive material having a high work function, preferably greater than 6.0 eV for a good hole injection property. In the current embodiment of the present invention, the second anode 27c is made out of ITO, IZO or the like, but the present invention is not limited thereto.

A pixel-defining layer 116 is formed using a fifth mask 35. The pixel-defining layer 116 defines a light emitting area. In addition, the pixel-defining layer 116 widens the distance between the edge of the first and second anodes 26b and 27c and a cathode 118 to prevent an electric field from concentrating at the edges of the first and second anodes 26c and 27c, thus preventing shorts between the first and second anodes 26c and 27c and the cathode 118.

Meanwhile, the cathode 118 is a light transmission common electrode. The cathode 118 is formed using a method including thinly depositing metal having a low work function, for example, Li, Ca, LiF/Ca, LiF/Al, Al, Ag, Mg and compounds thereof to face an organic layer 117, and depositing a material such as ITO, IZO, ZnO, In₂O₃ or the like for forming a transparent electrode on the resulting structure to form an auxiliary electrode layer or a bus electrode line.

An organic layer 117 including at least an emitting layer 117′ is formed between the second anode 27c and the cathode 118. The structure of the organic layer 117 can vary. The organic layer 117 can be a small-molecular weight organic layer or a polymer organic layer.

When the organic layer 117 is a small-molecular weight organic layer, the organic layer 117 can have a structure including one or combinations of a hole injection layer (HIL), a hole transport layer (HTL), an emission layer (EML), an electron transport layer (ETL), and an electron injection layer (EIL). Examples of organic materials used to form the small-molecular weight organic layer include copper phthalocyanine (CuPc), N,N-di(naphthalene-1-yl)-N,N′-diphenyl-benzidine (NPB), tris-8-hydroxyquinoline aluminum (Alq3), etc. The small-molecular weight organic layer can be formed using, for example, vacuum deposition.

When the organic layer 117 is a polymer organic layer, the organic layer 117 can have a structure including an HTL and an EML. The HTL can be made out of poly-3,4-ethylendioxythiophene (PEDOT), and the EML can be made out of a poly-para-phenylenevinylene(PPV)-based or polyfluorene-based polymer material applied by screen printing, inkjet printing, or the like.

As described above, the organic light emitting display device 200 can be manufactured using a simple and inexpensive method in which the number of masks is reduced by simultaneously forming the first and second anodes 26c and 27c, the source electrodes 26a and 27a and the drain electrodes 26b and 27b. The first anode 26c and the second anode 27c are formed in a multi-layer structure that includes a plurality of layers including layers made out of a conductive material having a low resistance and a conductive material having a high work function, respectively, thereby preventing a drop in voltage and the deterioration of hole injection properties which can occur when the first and second anodes 26c and 27c, the source electrodes 26a and 27a, and the drain electrodes 126b and 26b are integrally formed.

Turning now to FIG. 8, FIG. 8 is a schematic cross-sectional view illustrating an organic light emitting display device 300 according to another embodiment of the present invention. The manufacturing method and structure of the organic light emitting display device 300 are similar to those of the organic light emitting display device 200 of FIG. 2 except for the particulars relating to the anode. Thus, the differences between the organic light emitting display device 200 of FIG. 2 and the organic light emitting display device 300 of FIG. 8 will be mainly described and description of portions of the organic light emitting display device 300 similar to that of the organic light emitting display device 200 of FIG. 2 will be omitted.

A first anode 26c, a second anode 27c, and a third anode 28c are formed simultaneously with source and drain electrodes 26a, 27a, 28a, 26b, 27b and 28b using the fourth mask 34. Thus, since the number of the masks used in forming the first, second and third anodes 26c, 27c and 28c is reduced, the process of manufacturing the organic light emitting display device 300 according to the current embodiment of the present invention can be simple, thereby reducing manufacturing costs.

The third anode 28c contacts source and drain regions 22 and 23 through a via hole 25, which prevents the quality deterioration of the TFT. The quality deterioration of the TFT occurs when metal constituting the first anode 26c diffuses to contaminate a channel of a semiconductor layer 21. In particular, when the material constituting the first anode 26c contains at least one of Al, AlNd, ACX, AlNiLa and Ag, the contamination of the channel of the semiconductor layer 21 is increased by the first anode 26c. In order to prevent this, a third anode 28c is included and can be made out of at least one of Mo, Ti and MoW.

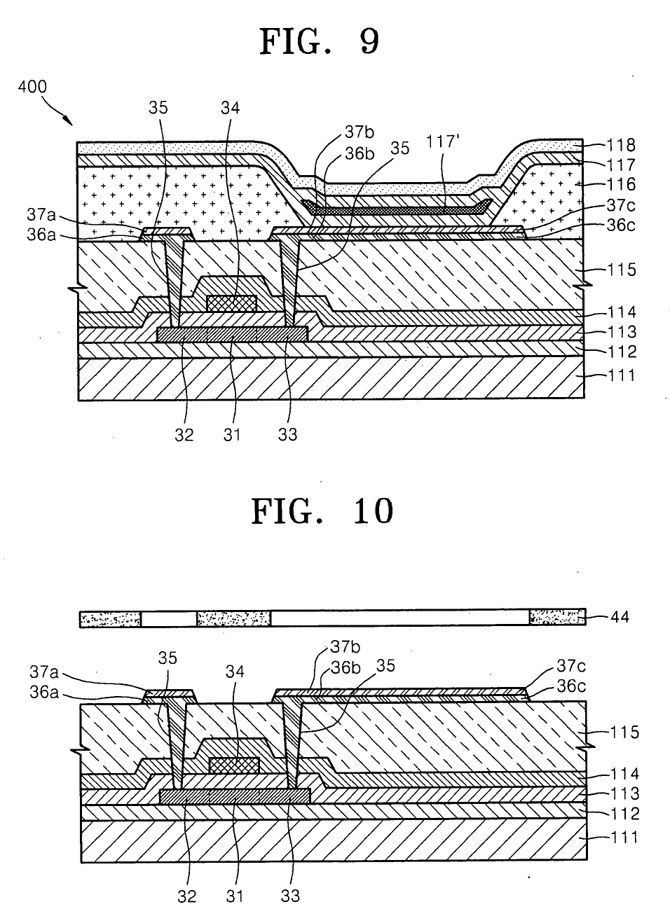

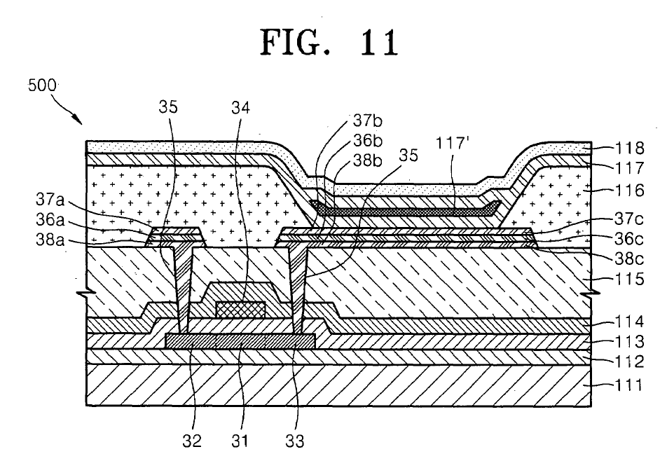

Turning now to FIGS. 9 and 10, FIG. 9 is a schematic cross-sectional view illustrating an organic light emitting display device 400 according to another embodiment of the present invention and FIG. 10 is a schematic cross-sectional view illustrating an operation of forming source and drain electrodes and an anode of FIG. 9 according to an embodiment of the present invention. The manufacturing method and structure of the organic light emitting display device 400 are similar to those of the organic light emitting display device 200 of FIG. 2 except regarding the particulars of the anode. Therefore, the following description will focus on the anode while omitting the other parts of the organic light emitting display device 400 that are similar to that of the organic light emitting display device 200 of FIG. 2.

Referring now to FIGS. 9 and 10, a first anode 36c and a second anode 37c are formed simultaneously with source electrodes 36a and 37a and the drain electrodes 36b and 37b and integrally with the source electrodes 36a and 37a or the drain electrodes 36b and 37b using the fourth mask 44. Accordingly, since the number of the masks used in forming the first and second anodes 36b and 37b is reduced, the process of manufacturing the organic light emitting display device 400 according to the current embodiment of the present invention can be simple, thereby reducing manufacturing costs.

In the current embodiment of the present invention, since the second anode 37b is made out of a conductive material having a high work function, the first anode 36b is a reflective anode for top emission. The first anode 36b is made out of a conductive material having high reflectivity, preferably, greater than 97% to improve output coupling efficiency of light. The first anode 36c can be made out of at least one of Al, AlNd, ACX, AlNiLa, Ag, Mo, Ti and MoW, however, the present invention is not limited thereto.

Turning now to FIG. 11, FIG. 11 is a schematic cross-sectional view illustrating an organic light emitting display device 500 according to another embodiment of the present invention. The manufacturing method and structure of the organic light emitting display device 500 are similar to those of the organic light emitting display device 400 of FIG. 9 except for the anode. Thus, the following description of the organic light emitting display device 500 of FIG. 11 will focus on the anode while omitting the description of other elements that are similar to the organic light emitting display device 400.

In FIG. 11, a first anode 36c, a second anode 37c and a third anode 38c are formed simultaneously with source electrodes 36a, 37a and 38a and the drain electrodes 36b, 37b and 38b and integrally with the source electrodes 36a, 37a or the drain electrodes 36b, 37b and 38b using the fourth mask 44. Accordingly, since the number of the masks used in forming the first, second and third anodes 36b, 37b and 38b is reduced, the process of manufacturing the organic light emitting display device 500 can be simple, thereby reducing manufacturing costs.

In the current embodiment of the present invention, the third anode 38c contacts the source and drain electrodes 38a and 38b through a via hole 35. Source and drain electrodes 38a and 38b serve to prevent the quality deterioration of the TFT by improving an adhesion between metal constituting the first anode 36c to source and drain regions 32 and 33 of semiconductor layer 31. In particular, when the first anode 36c is made out of at least one of Al, AlNd, ACX, AlNiLa and Ag, the quality deterioration of the TFT due to the reduction in adhesion between the first anode 36c and the source and drain electrodes 36a, 37a, 38a, 36b, 37b and 38b can occur. In order to prevent this, the third anode 38c made out of at least one of Mo, Ti and MoW is included and positioned underneath the first anode 36c to provide better adhesion between the first anode 36c and the underlying planarization layer 115 and the underlying source and drain regions 32 and 33 of semiconductor layer 31.

In the organic light emitting display device according to the present invention, the following advantages can be achieved. First, the anode layer is formed simultaneously with source and drain electrodes and integrally with the source or drain electrode using only one mask. Thus, the organic light emitting display device according to the present invention can be manufactured using a simple method to reduce manufacturing costs.

Second, since the anode layer is formed to have a multi-layer structure comprising a plurality of layers including a layer made out of a material having a high work function and a layer of material having a low resistance, respectively, the organic light emitting display device can have good hole transport properties while preventing an energy loss from occurring due to a drop in voltage.

Third, since the anode layer is formed to have a multi-layer structure comprising a plurality of layers including a layer made out of a material having a high work function and a layer of a material having high reflectivity, respectively, the organic light emitting display device can have good hole transport properties while preventing the reduction of output coupling efficiency of light due to the reduction of reflectivity.

While the present invention has been particularly shown and described with reference to exemplary embodiments thereof, it will be understood by those of ordinary skill in the art that various changes in form and details can be made therein without departing from the spirit and scope of the present invention as defined by the following claims.

What is claimed is:

1. An organic light emitting display device, comprising;
a substrate;
a thin film transistor arranged on the substrate and including a source electrode and a drain electrode;
a first anode, wherein the first anode and one of the source electrode and the drain electrode have at least one layer in common, are integral with each other and comprise a conductive material that has a low resistance;
a second anode arranged on the first anode and comprising a conductive material that has a high work function;
an organic layer arranged on the second anode; and
a cathode arranged on the organic layer.

2. The organic light emitting display device of claim 1, wherein the thin film transistor comprises:
a buffer layer;
a semiconductor layer arranged on the buffer layer;
a gate insulating layer arranged on the semiconductor layer;
a gate electrode arranged on the gate insulating layer;
a inter-insulator arranged on the gate electrode; and
a planarization layer arranged on the inter-insulator, the source and the drain electrode of the thin film transistor being arranged on the planarization layer and are connected to source and drain regions respectively of the semiconductor layer through a via hole.

3. The organic light emitting display device of claim 1, wherein the first anode comprises a conductive material having a surface resistance less than 0.7Ω/□.

4. The organic light emitting display device of claim 3, wherein the first anode comprises a material selected from a group consisting of Al, AlNd, ACX, AlNiLa, Ag, Mo, Ti and MoW.

5. The organic light emitting display device of claim 3, wherein a thickness of the first anode is less than 0.5 μm.

6. The organic light emitting display device of claim 1, wherein the second anode comprises a conductive material having a work function greater than 6.0 eV.

7. The organic light emitting display device of claim 6, wherein the second anode comprises a material selected from a group consisting of indium tin oxide and indium zinc oxide.

8. The organic light emitting display device of claim 2, further comprising a third anode including a conductive material and arranged between the first anode and the planarization layer, the third anode being adapted to prevent contamination of a channel of the semiconductor layer.

9. The organic light emitting display device of claim 8, wherein the first anode comprises a material selected from a group consisting of Al, AlNd, ACX, AlNiLa and Ag.

10. The organic light emitting display device of claim 8, wherein the third anode comprises a material selected from a group consisting of Mo, Ti and MoW.

11. An organic light emitting display device, comprising;
a substrate;
a thin film transistor arranged on the substrate and including a source electrode and a drain electrode;
a first anode, wherein the first anode and one of the source electrode and the drain electrode have at least one layer in common and are integral with each other;
a second anode arranged on the first anode and comprising a conductive material having a high work function;
an organic layer arranged on the second anode; and
a cathode arranged on the organic layer.

12. The organic light emitting display device of claim 11, the first anode and the one of the source electrode and the drain electrode comprise a conductive material having a high reflectivity.

13. The organic light emitting display device of claim 12, wherein the thin film transistor comprises:
a buffer layer;
a semiconductor layer arranged on the buffer layer;
a gate insulating layer arranged on the semiconductor layer;
a gate electrode arranged on the gate insulating layer;
a inter-insulator arranged on the gate electrode; and
a planarization layer arranged on the inter-insulator, the source and drain electrodes of the thin film transistor being arranged on the planarization layer and are connected to source and drain regions respectively of the semiconductor layer through a via hole.

14. The organic light emitting display device of claim 11, wherein the first anode comprises a conductive material having reflectivity greater than 97%.

15. The organic light emitting display device of claim 11, wherein the first anode comprises a material selected from a group consisting of Al, AlNd, ACX, AlNiLa, Ag, Mo, Ti and MoW.

16. The organic light emitting display device of claim 11, wherein the second anode comprises a conductive material having a work function greater than 6.0 eV.

17. The organic light emitting display device of claim 11, wherein the second anode comprises a material selected from a group consisting of indium tin oxide and indium zinc oxide.

18. The organic light emitting display device of claim 13, further comprising a third anode including a conductive material and arranged between the first anode and the planarization layer, the third anode being adapted to provide adhesion between the first anode and the source and drain regions of the semiconductor layer.

19. The organic light emitting display device of claim 18, wherein the first anode comprises a material selected from a group consisting of Al, AlNd, ACX, AlNiLa and Ag.

20. The organic light emitting display device of claim 18, wherein the third anode comprises a material selected from a group consisting of Mo, Ti, MoW, indium tin oxide and indium zinc oxide.
